(19) United States
(12) Patent Application Publication
(10) Pub. No.: US 2017/0163117 A1
(43) Pub. Date: Jun. 8, 2017

(54) STATOR OF DRIVING MOTOR AND COIL CONNECTION ASSEMBLY OF THE STATOR

(71) Applicant: Hyundai Motor Company, Seoul (KR)

(72) Inventors: Hyoungjun Cho, Suwon (KR); WoongChan Chae, Gwangmyeong (KR); Yeonho Kim, Suwon (KR); Sangjin Park, Hwaseong (KR)

(21) Appl. No.: 15/246,921

(22) Filed: Aug. 25, 2016

(30) Foreign Application Priority Data
Dec. 8, 2015 (KR) 10-2015-0174250

(51) Int. Cl. H02K 3/52

(52) U.S. Cl. CPC H02K 3/521

(57) ABSTRACT

A stator of a driving motor and a coil connection assembly of the stator is provided. The coil connection assembly of the stator of the driving motor includes a coil connection portion that is drawn from a stator coil wound on a stator core in multiple strands. A ring terminal is electrically connected to the coil connection portion. The ring terminal includes a cylindrical connection compressing portion fitted with multiple strands of coils of the coil connection portion that are compressed by a set pressing force and connected with the coils. A bolt fixing portion is integrally formed with the connection compressing portion and has a engagement bore configured to engage a bolt. Conductive protrusions that penetrate an insulating film of coils of the coil connection portion by the set pressing force are formed on the inner periphery of the connection compressing portion.

### CROSS-REFERENCE TO RELATED APPLICATION

This application claims priority to and the benefit of Korean Patent Application No. 10-2015-0174250 filed in the Korean Intellectual Property Office on Dec. 8, 2015, the entire contents of which are incorporated herein by reference.

### BACKGROUND

(a) Field of the Invention

The present invention relates to a stator of a driving motor, and more particularly, to a stator that electrically connects a ring terminal and coils by penetrating films of the coils of a coil connection portion by compression of the ring terminal.

(b) Description of the Related Art

Generally, a hybrid vehicle or an electric vehicle (e.g., an environmentally-friendly vehicle) generates drive force of an electric motor (hereinafter, referred to as a “driving motor”) obtaining rotary force with electric energy. The hybrid vehicle is driven in an electric vehicle (EV) mode which is a pure electric vehicle mode using power of the drive motor or driven in a hybrid electric vehicle (HEV) mode that uses both the rotary force of an engine and the rotary force of the drive motor as the power. Additionally, a general electric vehicle is driven using the rotary force of the drive motor as the power.

The driving motor applied to the environmentally-friendly vehicle includes a stator and a rotor. For example, the stator is joined into a motor housing and the rotor is disposed within the stator with a predetermined cavity. The stator of the driving motor includes a stator core formed by stacking electric steel plates and stator coils wound on slots of the stator core. Therefore, when alternating current (AC) is applied to the stator coil, a magnetic field is generated in the stator and torque is generated in the stator by the magnetic field.

Further, the driving motor is divided into a distribution winding type driving motor and a concentration winding type driving motor based on a winding scheme of the stator coils.

In particular, the stator of the distribution winding type driving motor is diversified based on the winding scheme of the stator coils and a distribution winding coil stator is representative. In the distribution winding coil stator, a coil connection portion is formed in 3 phases when the stator coils are connected. The 3-phase coil connection portion as a part where multi strands of coils are compressed is connected with a 3-phase power cable through a power terminal.

In the related art, the power terminal adopts a ring terminal and the ring terminal is connected with the coils of the coil connection portion and electrically connected with the power cable through a bolt. For example, the ring terminal is connected to the coil connection portion. Films of the coils of the coil connection portion are individually removed using a coil film remover. When the coils from which the films are removed are fitted into the ring terminal, the ring terminal is compressed using a compressing machine.

Further, the ring terminal is connected to the coil connection portion when the coil connection portion is fitted in the ring terminal while the coil connection portion is fixed to the ring terminal by pre-caulking the ring terminal. The ring terminal is compressed and fusing (e.g., resistance) welded and the films of the coils of the coil connection portions are resolved. However, in the former case, the films of the coils of the coil connection portion need to be individually removed using the coil film remover and thus, the working manpower increases. Additionally, in the latter case, expensive fusing welding equipment is required. Since foreign substances are generated by damages of the coil films while fusing welding, durability reliability deteriorates.

The above information disclosed in this section is merely for enhancement of understanding of the background of the invention and therefore it may contain information that does not form the prior art that is already known in this country to a person of ordinary skill in the art.

### SUMMARY

The present invention provides a stator of a driving motor and a coil connection assembly of the stator that electrically connects a ring terminal and coils by penetrating films of the coils of a coil connection portion by compression of the ring terminal.

An exemplary embodiment of the present invention provides a stator coil connection assembly of a driving motor that may include a coil connection portion drawn from a stator coil wound on a stator core in multiple strands and a ring terminal electrically connected to the coil connection portion. The ring terminal may include a cylindrical connection compressing portion fitted with multiple strands of coils of the coil connection portion, configured to be compressed by set pressing force and connected with the coils. A bolt fixing portion may be integrally formed with the connection compressing portion and may include an engagement bore configured to engage a bolt. Conductive protrusions that penetrate an insulating film of coils of the coil connection portion by the set pressing force may be formed on the interior periphery of the connection compressing portion.

The protrusions may be formed on the interior periphery of the connection compressing portion in a sawtooth shape. The conductive protrusions may be formed to protrude on the interior periphery of the connection compressing portion in a multi-pin shape. The conductive protrusions may be formed on the whole interior periphery of the connection compressing portion. The conductive protrusions may be formed on the interior periphery of a portion of the connection compressing portion.

Another exemplary embodiment of the present invention provides a stator of a driving motor that may include a stator core, stator coils wound on the stator core, a coil connection portion drawn from the stator coils in multiple strands and a ring terminal electrically connected to the coil connection portion. The ring terminal may include a cylindrical connection compressing portion in which multiple strands of coils of the coil connection portion may be fitted, and may be compressed by set pressing force and connected with the coils. A bolt fixing portion may be integrally formed with the connection compressing portion and may have an engagement bore configured to engage a bolt. The conductive protrusions which penetrate an insulating film of coils of the coil connection portion coils by the set pressing force may be formed on the interior periphery of the connection compressing portion.

The protrusions may be formed on the inner periphery of the connection compressing portion in a sawtooth shape. The conductive protrusions may be formed to protrude on the inner periphery of the connection compressing portion in a multi-pin shape. The conductive protrusions may be formed on the whole inner periphery of the connection compressing portion. The conductive protrusions may be formed on the inner periphery of a part of the connection compressing portion.

### BRIEF DESCRIPTION OF THE DRAWINGS

The drawings are used for reference in describing exemplary embodiments of the present invention and thus, the technical spirit of the present invention should not be analyzed to be limited to the accompanying drawings.

FIG. 1 is an exemplary perspective view of a stator of a driving motor according to an exemplary embodiment of the present invention;

FIG. 2 is an exemplary exploded perspective view of a stator coil connection assembly of the driving motor according to the exemplary embodiment of the present invention;

FIG. 3 is an exemplary combined perspective view of the stator coil connection assembly of the driving motor according to the exemplary embodiment of the present invention;

FIG. 4 is an exemplary perspective view illustrating a modification example of a ring terminal applied to the stator coil connection assembly of the driving motor according to the exemplary embodiment of the present invention;

FIG. 5 is an exemplary exploded perspective view of a stator coil connection assembly of a driving motor according to another exemplary embodiment of the present invention; and

FIG. 6 is an exemplary perspective view illustrating a modification example of a ring terminal applied to the stator coil connection assembly of the driving motor according to another exemplary embodiment of the present invention.

### DESCRIPTION OF SYMBOLS

10: Stator core

30: Stator coil

50: Coil connection portion

51: Coils

52a: Copper wire

52b: Insulating film

70: Ring terminal

71: Connection compressing portion

73: Bolt fixing portion

75: Engagement bore

81, 181: Conductive protrusions

### DETAILED DESCRIPTION

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

The drawings and description are to be regarded as illustrative in nature and not restrictive and like reference numerals designate like elements throughout the specification. Since size and thickness of each component illustrated in the drawings are arbitrarily represented for convenience in explanation, the present invention is not particularly limited to the illustrated size and thickness of each component and the thickness is enlarged and illustrated in order to clearly express various parts and areas.

In addition, in the following detailed description, names of components, which are in the same relationship, are divided into “the first”, “the second”, and the like to distinguish the components, but the present invention is not limited to the order. In addition, “unit”, “means”, “part”, “member”, or the like, which is described in the specification, means a unit of a comprehensive configuration that performs at least one function or operation.

While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed there between.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

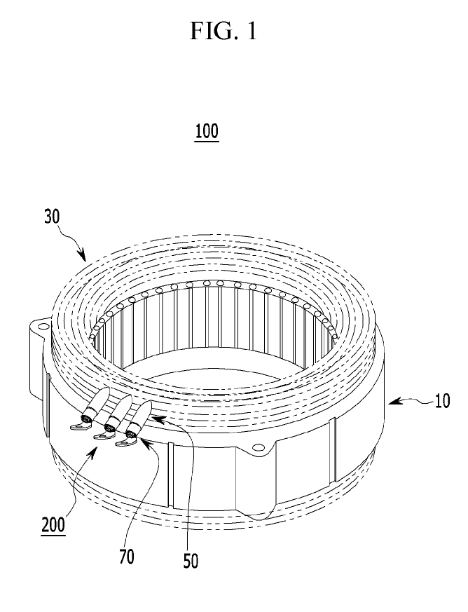

FIG. 1 is an exemplary perspective view of a stator of a driving motor according to an exemplary embodiment of the present invention. Referring to FIG. 1, the stator 100 according to the exemplary embodiment of the present invention may be applied to a driving motor configured to generate drive force with electric energy in environmentally-friendly vehicles (e.g., a hybrid vehicle, an electric vehicle, a fuel cell vehicle, and the like). The driving motor may be an interior synchronous motor with a rotor (not illustrated) disposed within the stator 100. The driving motor may include a motor housing (not illustrated), the stator 100 may be installed within the motor housing, and the rotor (not illustrated) may be rotatably installed in the stator 100 from the stator 100 with a predetermined cavity. The driving motor applied to the exemplary embodiment of the present invention may include a permanent magnet synchronous motor (PMSM) with a permanent magnet may be disposed in the rotor or a wound rotor synchronous motor (WRSM) with rotor coils wound on the rotor.

As described above, the stator 100 according to the exemplary embodiment of the present invention may be applied to the driving motor of the environmentally-friendly vehicle. However, it should not be construed that the protection scope of the present invention is not particularly limited thereto and the technical spirit of the present invention may be applied to various types and purposes of driving motors.

The stator 100 of the driving motor according to the exemplary embodiment of the present invention may include a stator core 10 fixed by stacking a plurality of sheets of electric steel plates and stator coils 30 wound on the stator core 10. A plurality of slots may be positioned toward a central axis in a circumferential direction in the stator core 10 and the stator coils 30 may be wound to the slots. Since the stator structure of the driving motor includes a state of a driving motor widely known in the relevant field, more detailed description of the structure will be omitted in the present specification. The stator 100 of the driving motor according to the exemplary embodiment of the present invention may include a stator coil connection assembly 200 that connects 3-phase coils drawn from the stator coils 30 in 3 phases (e.g., u, v, and w phases) and electrically connects the connection portion with a power cable (not illustrated).

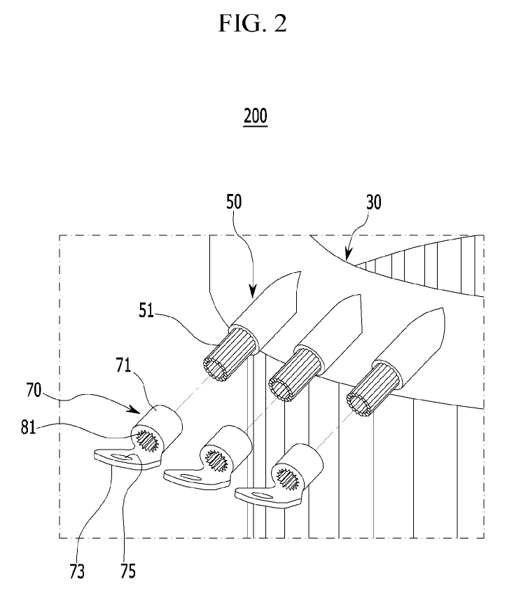

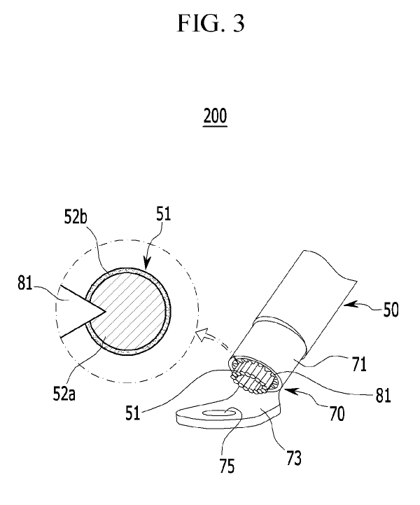

The stator coil connection assembly 200 of the driving motor according to the exemplary embodiment of the present invention may include a 3-phase coil connection portion 50 drawn from the stator coils 30 in multiple strands and a ring terminal 70 as a power terminal to electrically connect the coil connection portion 50 with a 3-phase power cable. The ring terminal 70 may be connected with multiple strands of connection coils (hereinafter, referring to FIGS. 2 and 3) (e.g., “coils”) of the coil connection portion 50 by a compression mode and may be electrically connected with the power cable via a bolt (not illustrated).

FIG. 2 is an exemplary exploded perspective view of a stator coil connection assembly of the driving motor according to the exemplary embodiment of the present invention. FIG. 3 is an exemplary combined perspective view of the stator coil connection assembly of the driving motor according to the exemplary embodiment of the present invention. Referring to FIGS. 2 and 3, in the stator coil connection assembly 200 of the driving motor according to the exemplary embodiment of the present invention, the ring terminal 70 may include a connection compressing portion 71 and a bolt fixing portion 73.

Multiple strands of coils 51 of the coil connection portion 50 may maintain a fixed position while being fitted in the connection compressing portion 71. The coil connection portion 71 may be a cylindrical cylinder type with an open first end and an open second end. The connection compressing portion 71 may be compressed by pressing force determined by a compressing machine (not illustrated) and may be connected with the coils 51 of the coil connection portion 50. For example, the connection compressing portion 71 may have an inner periphery disposed within the coils 51 of the coil connection portion 50. The bolt fixing portion 73 connected to the 3-phase power cable through the bolt may be integrally formed with the connection compressing portion 71. The bolt fixing portion 73 may be a substantially circular plate shape integrally connected to a first portion of a first end of the connection compressing portion 71 and a bolt aperture 75 formed on the circular plate may be configured to engage the bolt.

The coil connection assembly 200 of the driving motor according to the exemplary embodiment of the present invention has a structure in which the ring terminal 70 and the coils 51 of the coil connection portion 50 may be electrically connected. For example, the connection compressing portion 71 may be compressed to connect the coil connection portion 50. In other words, in the exemplary embodiment of the present invention, the stator coil connection assembly 200 of the driving motor may be compressed by the compressing machine to penetrate an insulating film 52b of the coil connection portion coils 51 with the connection compressing portion 71 of the ring terminal 70 and may electrically connect the coil connection portion 50 and the power cable.

In particular, conductive protrusions 81 may be formed at the connection compressing portion 71 into the coils 51 of the coil connection portion 50. The coils 51 of the coil connection portion 50 may include an exterior conductive surface of a copper wire 52a coated with the non-conductive insulating film 52b as illustrated in FIG. 3. The conductive protrusions 81 may electrically connect (e.g., conduct) the connection compressing portion 71, the coils 51 and the connection compressing portion 71 when the connection compressing portion 71 is compressed the insulating film 52b of the coils 51 may be penetrated by the pressing force. For example, the connection compressing portion 71 may be compressed with the set pressing force through the compressing machine. The coils 51 of the coil connection portion 50 may be fitted in the connection compressing portion 71 of the ring terminal 70.

In the exemplary embodiment of the present invention, when the connection compressing portion 71 with the coils 51 of the coil connection portion 50 of the conductive protrusion 81 are fitted is compressively deformed. The conductive protrusions 81 may be formed on the inner periphery of the connection compressing portion 71 in a pointed shape to be connected to a copper wire 52a by penetrating the insulating film 52b of the coil connection portion coils 51. For example, the conductive protrusions 81 may be formed on the inner periphery of the connection compressing portion 71 in a multi-sawtooth shape. In particular, since the conductive protrusions 81 may be formed on the whole inner periphery of the connection compressing portion 71, the conductive protrusion 81 may elongate from a first end to a second end of the connection compressing portion 71 and the conductive protrusions 81 may be consecutively formed on the inner periphery of the connection compressing portion 71 in the interior peripheral direction thereof.

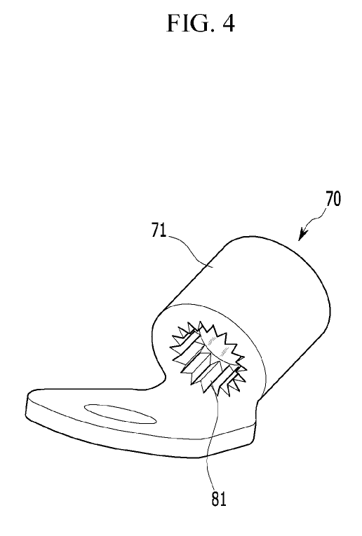

Further, the ring terminal 70 is not limited to when the conductive protrusions 81 are formed on the whole inner periphery of the connection compressing portion 71. As a modified example of the ring terminal 70, the conductive protrusions 81 may be formed on the inner periphery of a part of the connection compressing portion 71 as illustrated in FIG. 4. The conductive protrusions 81 may be formed at a substantially middle portion of one end of the connection compressing portion 71 and may be formed on the whole inner periphery of the connection compressing portion 71 in the inner peripheral direction thereof.

Hereinafter, a process of connecting the stator coil of the driving motor using the stator coil connection assembly 200 of the driving motor according to the exemplary embodiment of the present invention, which is configured as above will be described in detail with reference to the disclosed drawings.

First, in the exemplary embodiment of the present invention, 3-phase coils drawn from the stator coils 30 wound on the stator core 10 in 3 phases (e.g., u, v, and w phases) may be connected to form the coil connection portion 50. When the 3-phase coil connection portion 50 is formed as described above, the coils 51 of the coil connection portion 50 may be fitted in the connection compressing portion 71 of the ring terminal 70. In particular, the coils 51 of the coil connection portion 50 may be connected in a ring shape that corresponds to the inner periphery of the connection compressing portion 71 and may be fitted in the inner periphery side of the connection compressing portion 71.

Then, the connection compressing portion 71 may be compressed by the set pressing force of the compressing machine. Therefore, the connection compressing portion 71 may be compressed and deformed by the compressing machine when the coils 51 of the coil connection portion 50 are fitted in the connection compressing portion 71. During this process, the conductive protrusions 81 on the inner periphery of the connection compressing portion 71 may penetrate the insulating film 52b of the coils 51 by the pressing force of the compressing machine.

Therefore, in the exemplary embodiment of the present invention, the conductive protrusions 81 of the connection compressing portion 71 may penetrate the insulating film 52b of the coils 51 to be connected to the copper wire 52a and the coils 51 of the coil connection portion 50. The connection compressing portion 71 may be electrically connected through the conductive protrusions 81. When the bolt fixing portion 73 of the ring terminal 70 and the power cable are engaged to each other through the bolt, the 3-phase coil connection portion 50 of the stator coils 30 and the power cable may be connected to be conductible via the ring terminal 70.

According to the stator 100 of the driving motor according to the exemplary embodiment of the present invention described above and the coil connection assembly 200 thereof, the ring terminal 70 and the coil connection portion 50 may be electrically connected with each other through the conductive protrusions 81 of the connection compressing portion 71 by the compressing of the connection compressing portion 71. In other words, in the exemplary embodiment of the present invention, the compressing of the connection compressing portion 71 of the ring terminal 70 and the film peel-off of the coils 51 by the conductive protrusions 81 of the connection compressing portion 71 may be simultaneously implemented.

Therefore, in the exemplary embodiment of the present invention, a process of individually removing (e.g., peeling off) the films of the coils 51 of the coil connection portion or removing the films while fusing-welding the connection compressing portion 71 of the ring terminal 70 and the coils 51 may be omitted in addition to the process of compressing the connection compressing portion 71 of the ring terminal 70 in the related art. Accordingly, in the exemplary embodiment of the present invention, the requirement that the films of the coils of the coil connection portion are individually removed by using a coil film remover may be solved. A 3-phase coil connection operation of the stator coils and a power cable connection assembly process of a stator coil may be simplified. Further, in the exemplary embodiments, since an expensive fusing welding equipment as used in the related art is not required, manufacturing cost of a stator may be reduced and generation of foreign substances as the coils films are damaged by the fusing welding in the may be resolved, and, durability reliability of a motor may be improved.

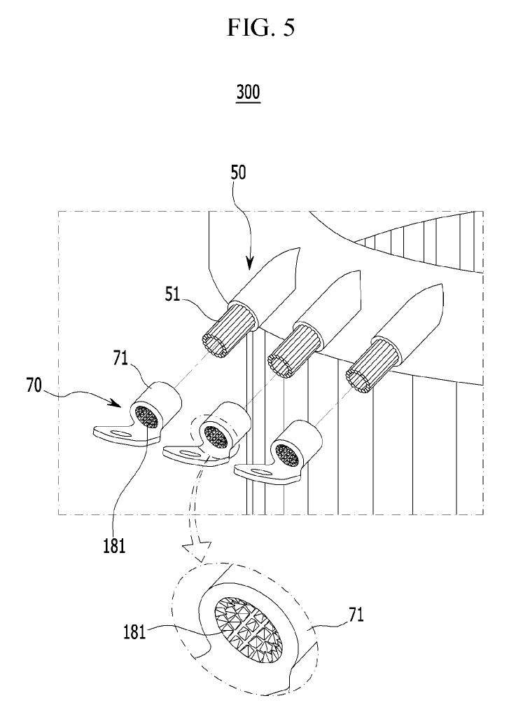

FIG. 5 is an exemplary exploded perspective view of a stator coil connection assembly of a driving motor according to another exemplary embodiment of the present invention. Referring to FIG. 5, the stator coil connection assembly 300 of the driving motor according to another exemplary embodiment of the present invention, the ring terminal 70 may include pin-shaped pointed conductive protrusions 181 formed in the connection compressing portion 71 into which the coils 51 of the coil connection portion 50 may be fitted and fixed.

The conductive protrusions 181 may be formed to integrally protrude on the inner periphery of the connection compressing portion 71 and may be provided in a pointed pin shape (e.g., or the like) in which the conductive protrusions 181 are individually distributed on the interior periphery thereof. In other words, the conductive protrusions 181 may be uniformly distributed from a first end to a second end of the connection compressing portion 71 on the interior periphery of the connection compressing portion 71. When the connection compressing portion 71 is compressed by the set pressing force while the coils 51 of the coil connection portion 50 are fitted in the connection compressing portion 71, the conductive protrusions 181 may penetrate the insulating film (see FIG. 3) 52b of the coils 51 by the pressing force to be connected to the copper wire (see FIG. 3) 52a.

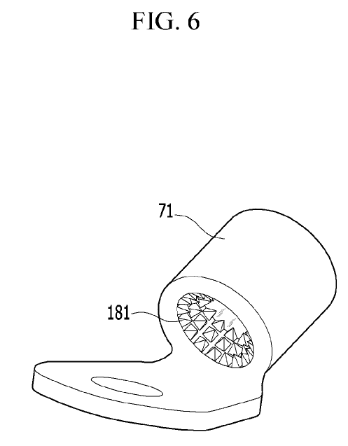

The conductive protrusions 181 according to another exemplary embodiment of the present invention are not particularly limited to the case in which the conductive protrusions 181 protrude on the inner periphery of the connection compressing portion 71. As a modified example illustrated in FIG. 6, the conductive protrusions 181 may be formed to protrude on the inner periphery of a portion of the connection compressing portion 71. The conductive protrusions 181 may be formed up to the substantially middle portion from a first end of the connection compressing portion 71 and may be uniformly distributed on the inner periphery of the connection compressing portion 71 in the inner peripheral direction thereof.

Since remaining configurations and operational effects of the stator coil connection assembly 300 of the driving motor according to another exemplary embodiment of the present invention are the same as those of the exemplary embodiment, more detailed description will be omitted.

According to exemplary embodiments of the present invention, since a ring terminal and a coil connection portion may be electrically connected with each other through conductive protrusion of a connection compressing portion by compression of the connection compressing portion, a process of individually removing (e.g., peeling off) the films of the coils of the coil connection portion or fusing-welding the connection compressing portion and the coils and removing the films may be omitted in addition to a process of compressing the connection compressing portion of the ring terminal as described in the related art.

Therefore, in the exemplary embodiments of the present invention, the films of the coils of the coil connection portion that are required to be individually removed by using a coil film remover in the related art may be solved. Further, a 3-phase coil connection operation of the stator coil and a power cable may be used to improve the manufacturability of a stator coil. Further, in the exemplary embodiments, since expensive fusing welding equipment in the related art is not required, manufacturing cost of a stator may be reduced. Additionally, generation of foreign substances as the coils films are damaged by the fusing welding in the related art may be omitted and as a result, durability reliability of a motor may be improved.

While this invention has been described in connection with what is presently considered to be exemplary exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A coil connection assembly of a stator of a driving motor, comprising:
a coil connection portion drawn from a stator coil wound on a stator core in multiple strands; and
a ring terminal electrically connected to the coil connection portion,
wherein the ring terminal includes a cylindrical connection compressing portion fitted with multiple strands of coils of the coil connection portion, compressed by a set pressing force, and connected with the coils, and a bolt fixing portion integrally formed with the connection compressing portion and having an engagement bore configured to engage to a bolt, and
wherein conductive protrusions formed on the inner periphery of the connection compressing portion penetrate an insulating film of the coils of the connection portion by the set pressing force.

2. The coil connection assembly of claim 1, wherein the protrusions are formed on the inner periphery of the connection compressing portion in a sawtooth shape.

3. The coil connection assembly of claim 1, wherein the conductive protrusions are formed to protrude on the inner periphery of the connection compressing portion in a multi-pin shape.

4. The coil connection assembly of claim 1, wherein the conductive protrusions are formed on the whole inner periphery of the connection compressing portion.

5. The coil connection assembly of claim 1, wherein the conductive protrusions are formed on the inner periphery of a portion of the connection compressing portion.

6. A stator of a driving motor, comprising:
a stator core;
stator coils wound on the stator core;
a coil connection portion drawn from the stator coils in multiple strands; and
a ring terminal electrically connected to the coil connection portion,
wherein the ring terminal includes a cylindrical connection compressing portion fitted with multiple strands of coils of the coil connection portion, and compressed by a set pressing force and connected with the coils, and a bolt fixing portion integrally formed with the connection compressing portion and having an engagement bore configured to engage a bolt, and
wherein conductive protrusions are formed on the inner periphery of the connection compressing portion penetrate an insulating film of coils of the coil connection portion by the set pressing force.

7. The stator of claim 6, wherein the protrusions are formed on the inner periphery of the connection compressing portion in a sawtooth shape.

8. The stator of claim 6, wherein the conductive protrusions are formed to protrude on the inner periphery of the connection compressing portion in a multi-pin shape.

9. The stator of claim 6, wherein the conductive protrusions are formed on the whole inner periphery of the connection compressing portion.

10. The stator of claim 6, wherein the conductive protrusions are formed on the inner periphery of a portion of the connection compressing portion.
